(19) United States
(12) Patent Application Publication
(10) Pub. No.: US 2017/0099864 A1
(43) Pub. Date: Apr. 13, 2017

(54) PROCESS FOR PRODUCING POULTRY SAUSAGE

(71) Applicants: Deutsches Institut fuer Lebensmitteltechnik e.V., Quakenbrueck (DE); Heinrich Noelke GmbH & Co. KG, Versmold (DE)

(72) Inventor: Ute Bindrich, Quakenbrueck (DE)

(21) Appl. No.: 14/879,651

(22) Filed: Oct. 9, 2015

(51) Int. Cl. A23L 1/315

(52) U.S. Cl. CPC A23L 13/52; A23V 2002/00

(57) ABSTRACT

The invention relates to a process for producing a firm poultry fat product and a process for producing poultry sausage solely based on poultry, and without additional bacon from pork or vegetable fat resp. The poultry fat product obtainable by the process may be produced solely on the basis of poultry skin which is comminuted and heated. The strength of the poultry fat product is sufficient at room temperature.

The invention relates to a process for producing a firm poultry fat product and a process for manufacturing poultry sausage solely based on poultry or without additional bacon from pork or vegetable fat.

The process and the poultry fat product obtainable through the process, and respectively the poultry sausage are characterized by not containing any amount of fat from mammals, in particular no bacon from pork or vegetable fat, but protein and fat may exclusively originate from poultry. The poultry may be chicken or rooster (together referred to as chicken), turkey or turkey hen (together referred to as turkey), goose, guinea fowl, etc. The poultry fat product may be produced of poultry skin. Poultry sausage in which the poultry fat product is highly dispersed and/or is present in the form of visible particles may be produced by mixing the poultry fat product with muscle and/or connective tissue from poultry and food additives, cooling, optionally smoking and/or ripening. The fat phase of the poultry sausage may consist of the poultry fat product and, accordingly, the poultry fat product may be used as a fat phase of food, in particular of poultry sausage.

### STATE OF THE ART

Regarding the manufacture of sausage, poultry fat has the disadvantage of having a low melting point and of leaking oil, for example at room temperature.

An object of the invention is to provide a process and a product obtainable through the process, by which, based on poultry, preferably poultry components except for muscles tissue, poultry fat may be converted into a form suitable for the manufacture of sausage. A preferred object is to provide a process for manufacturing poultry sausage not containing any amount of fat from mammals or vegetable fat, wherein further preferred the poultry fat is highly dispersed and/or forms visible and firm particles in the poultry sausage.

### GENERAL DESCRIPTION OF THE INVENTION

The invention accomplishes the object by means of the features of the claims, in particular by a process for producing a poultry fat product comprising the steps of:
Comminuting a first raw or uncooked poultry skin, in particular up to cell decomposition, in particular by grinding and cutting, in the presence of admixed water, e.g. at a weight proportion of from 1:0.5 to 1:2, to which preferably from 0.7 to 2% (w/w), more preferably from 0.8 to 1.2% (w/w), even more preferably from 0.9 to 1% (w/w) salt (NaCl) is added, preferably at only slight heating, in particular at from about 0 to 10° C., preferably from 3 to 5° C., for generating a first comminuted raw poultry skin. The water may be added in the form of ice and/or liquid water. For comminuting in the presence of admixed water the first raw or uncooked poultry skin preferably is grinded. Optionally, the raw poultry skin is comminuted by grinding, followed by mixing with water, to which salt is preferably added, and then is further comminuted by cutting.
A first heat treatment of the first comminuted raw poultry skin at from 55° C. to 75° C. for from 1 to 3 h, preferably up to 2 h at 65° C., more preferably at 60° C. for about 1.5 h, for generating a first heat treated comminuted poultry skin.
Emulsifying the first heat treated comminuted poultry skin by fine grinding, e.g. using a rotor-stator disperser, a colloid grinder, and/or a cutter for producing an emulsion. Preferably, emulsifying is proceeded until the emulsion shows a bright color, since this indicates highly dispersed fat.
Comminuting a second raw or uncooked poultry skin, in particular by grinding and cutting, optionally up to cell decomposition, preferably at only slight heating, in particular at from about 0 to 10° C., preferably from 3 to 5° C., and mixing with water, e.g. at a weight portion of from 1:0.25 to 1:2, preferably wherein from 0.5 to 2% (w/w), more preferably from 0.8 to 1.2% (w/w), even more preferably from 0.9 to 1% (w/w) salt (NaCl) is added to the water, for generating a second comminuted raw poultry skin. The water or the salt solution may be added in the form of ice and/or liquid water. Preferably, comminuting is effected by coarsely comminuting or hackling, in particular coarsely grinding or grinding, of the second raw poultry skin, followed by mixing with water, to which salt is preferably added, for generating the second comminuted raw poultry skin.
A second heat treatment of the second comminuted raw poultry skin at from 70° C. to 90° C. for from 1 to 5 h, preferably at from 75 to 85° C., more preferably at from 80° C. for 2 to 4 h, even more preferably for 3 h, for generating a second heat treated comminuted poultry skin.
Comminuting the second heat treated comminuted poultry skin, in particular by cutting, optionally up to cell decomposition, for producing a gel precursor.
Bringing the emulsion and the gel precursor to approximately the same temperature, which preferably is a temperature involving a tolerance of at maximum 5° C., more preferably of at maximum 2° C., even more preferably of at maximum 1.5° C., and mixing the emulsion and the gel precursor, e.g. at a mass ratio of from 90:10 to 50:50 gel precursor:emulsion, the temperature preferably being from 30° C. to 60° C., more preferably from 45° C. to 55° C., even more preferably of at maximum 50° C., e.g. from 45 to 50° C., for generating a mixture containing or consisting of the emulsion and the gel precursor, and
Cooling the mixture of emulsion and gel precursor, in particular to from 0 to 7° C., preferably to at maximum 3° C., for generating the poultry fat product of the invention. The mixture of emulsion and gel precursor solidifies by cooling, resulting in the poultry fat product. Preferably, cooling is carried out at a maximal layer height of from 1 to 5 cm, e.g. at a layer height of from 2 to 4 cm, e.g. in a cooling chamber or a cooling tunnel.
Optionally, particles of connective tissue from poultry may be added to the mixture of emulsion and gel precursor prior to cooling, so that the mixture may contain or consist of the emulsion, gel precursor, connective tissue particles and optionally added food additives. The connective tissue particles are comminuted, preferably grinded, and cooked, further preferably showing a bright color. The connective tissue particles may be added at from 5 to 30% (w/w), preferably up to 20% (w/w), in particular at 10% (w/w), relative to the weight of the mixture of emulsion and gel precursor. The addition of connective tissue particles results in an increase of gel strength of the poultry fat product. These particles of connective tissue may be produced by cooking comminuted, preferably grinded poultry skin, which preferably is bright, in few water or steam, removing liquid, e.g. by spinning down at 5,000×g for 15 min. Water or steam, e.g. in a weight ratio of from 0.1 to 0.5, relative to the weight of the poultry skin, may be used for cooking. The cooking may be carried out, for example, at from 72 to 120° C. for from 20 min to 4 h.
As generally preferred, the comminuting for producing the first and optionally the second comminuted raw poultry skin is effected at low temperature to achieve better sensory properties, in particular to avoid a taste of cooking. Preferably, comminuting is effected at a temperature of at maximum 10° C., more preferably at maximum 5° C., even more preferably at maximum 3° C. Preferably, comminuting of the first and/or second poultry skin is effected by cutting and/or while cooling. The first and optionally the second comminuted raw poultry skin may be generated through the same steps from a different raw poultry skin each or from the same raw poultry skin, which may originate from one sort of poultry species, or may be a mixture of poultry skin, e.g. of turkey and chicken skin, by comminuting, in particular up to cell decomposition, in particular at first by grinding, followed by cutting of the grinded poultry skin in mixture with water, e.g. at a weight proportion of from 1:0.5 to 1:2, to which preferably from 0.7 to 2% (w/w), more preferably from 0.8 to 1.2% (w/w), even more preferably from 0.9 to 1% (w/w) salt (NaCl) is added, preferably at only slight heating, in particular at from about 0 to 10° C., preferably from 3 to 5° C. The water maybe added in the form of ice and/or liquid water.
Further optionally, the poultry fat product solidified by cooling, optionally comminuted, may be contacted with salt, in particular solid salt, and leaking liquid may be separated or removed, e.g. by letting drain the poultry fat product on a porous support, e.g. a sieve. The amount of salt the poultry fat product is contacted with can be chosen freely, a single layer of salt, e.g. from 0.1 to 1 mm, on the surface of the poultry fat product being preferred. This reduction of liquid content of the poultry fat product increases the gel strength.

The term “grinding” generally means a coarse size reduction, e.g. by means of a grinder involving a punched disk, or a meat grinder, e.g. to a mean particle size of 5 to 10 mm.

For the purposes of the invention, the gel being part of the poultry fat product, generated from the second poultry skin, which is still liquid prior to gelatinizing or cooling is referred to as gel precursor.

The poultry skin preferably originates from turkey or chicken and preferably is free from components from other animals, in particular free from fat from mammals, and free from vegetable fat. Preferably, the poultry skin is skin from poultry breast. The first and the second poultry skin may be of the same composition, e.g. 100% turkey or 100% chicken skin, or of a mixture of skin from poultry breast from chicken and turkey, e.g. 10 to 90% chicken, preferably 30%, more preferably 50%, even more preferably 70% or 80%, the rest being turkey in each case.

The poultry fat product has a brightness value L* of at least 80 and is thus suitable as a phase in poultry sausage. Without admixed connective tissue the pressure strength of the poultry fat product is sufficient for a fat phase in poultry sausage and amounts to e.g. from 4,800 to at least 5,500 Pa. The amount of fat extractable from the poultry fat product is from 50 to 65%, in particular from 55 to 63%, in case the poultry skin is skin from poultry breast, 70% chicken and 30% turkey, and shows sufficient stabilization of the fat. In case of admixed connective tissue, pressure strength of the poultry fat product of at least 15,000 Pa, preferably at least 20,000 Pa, more preferably at least from 22,000 Pa to 25,000 Pa may be achieved.

Having a boundary temperature for liquefaction of at least 34° C., preferably at least 35° C., the temperature stability of the poultry fat product is sufficient. Up to temperatures of about 10° C. the decrease in strength is very low, while above 10° C. the poultry fat product becomes softer, but dimensionally stable. The poultry fat product gelatinizes thermo reversibly having the consequence that it liquefies when the boundary temperature of temperature stability is exceeded, and re-solidifies after cooling below that boundary temperature. It is thus preferred that the process proceeds at temperatures of at maximum 10° C., preferably at maximum 7° C., more preferably at maximum 5° C. The storage temperature of the poultry fat product should not exceed 25° C.

In the production of poultry sausage, preferably poultry raw sausage, the poultry fat product may be used as a fat phase.

The poultry fat product may be used for producing poultry raw sausage, e.g. coarse poultry raw sausage, by:
Comminuting the cooled poultry fat product, e.g. by cutting into cubes, grinding or cutting, preferably while cooling;
Comminuting of cooled poultry lean meat, preferably while cooling, e.g. by grinding or cutting;
Mixing the comminuted poultry fat product and the comminuted poultry lean meat while adding food additives, preferably salt, spices and starter culture;
Casing, e.g. in sausage casing;
Optionally, pre-drying;
Optionally, cold smoking.
Ripening.

Preferably, the poultry fat product and the poultry lean meat are cooled prior to being comminuted e.g. to at maximum 10° C., preferably to at maximum 5° C., more preferably to at maximum 3° C.

The food additives are preferably selected from salt, nitrite, phosphate, spices, starter cultures, preservatives, and/or sugar, e.g. lactose, glucose and/or fructose. For spices, herbs, mustard, liquid smoke etc. may be used.

### DETAILED DESCRIPTION OF THE INVENTION

In the following, the invention will be described in more detail based on the examples referring to the figures in which:

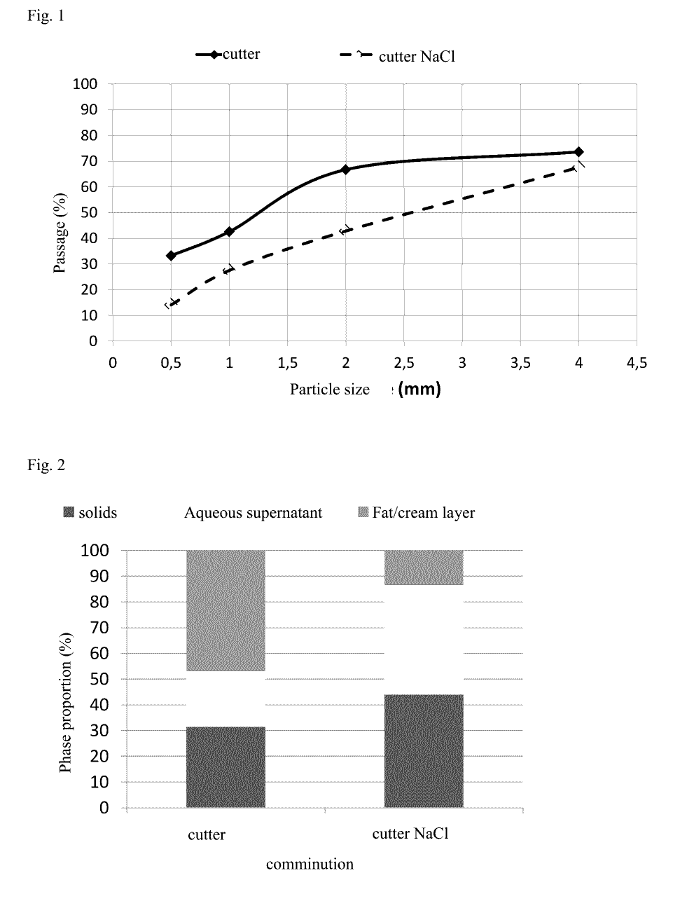

FIG. 1 shows the particle size distribution of the first comminuted raw poultry skin, determined by sieving;

FIG. 2 shows the volumetric phase proportions of the first comminuted raw poultry skin;

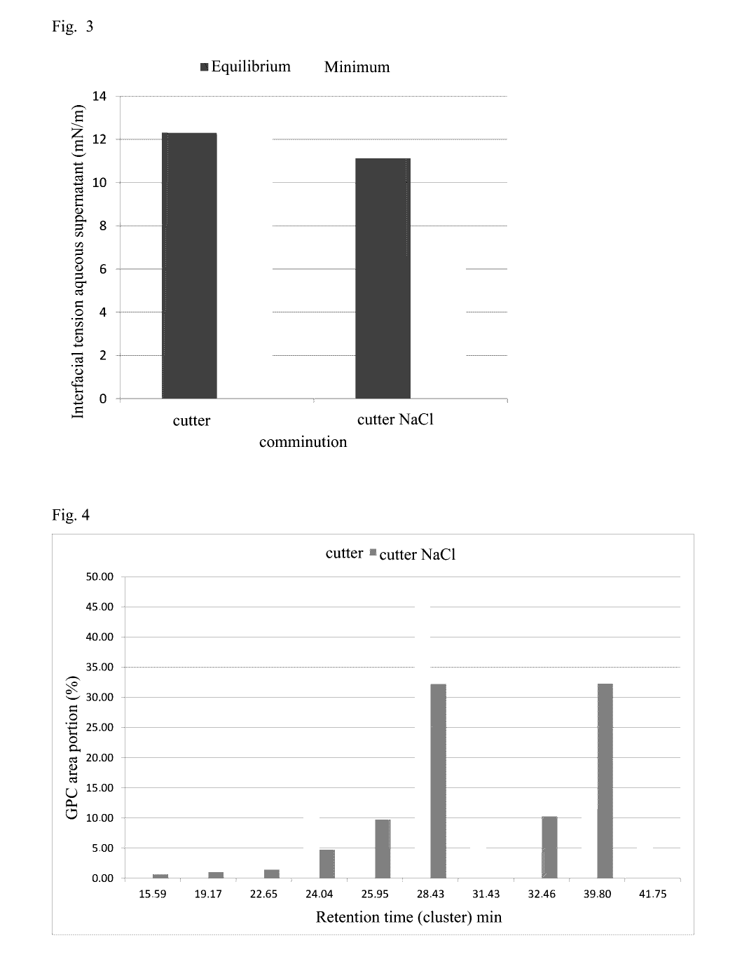

FIG. 3 shows the interfacial tension of the aqueous phase of the first comminuted raw poultry skin;

FIG. 4 shows the relative molecular sizes of soluble proteins of the first comminuted raw poultry skin in terms of retention times in gel permeation chromatography;

FIG. 5 shows the brightness values of the aqueous supernatant of the first comminuted raw poultry skin after a first heat treatment;

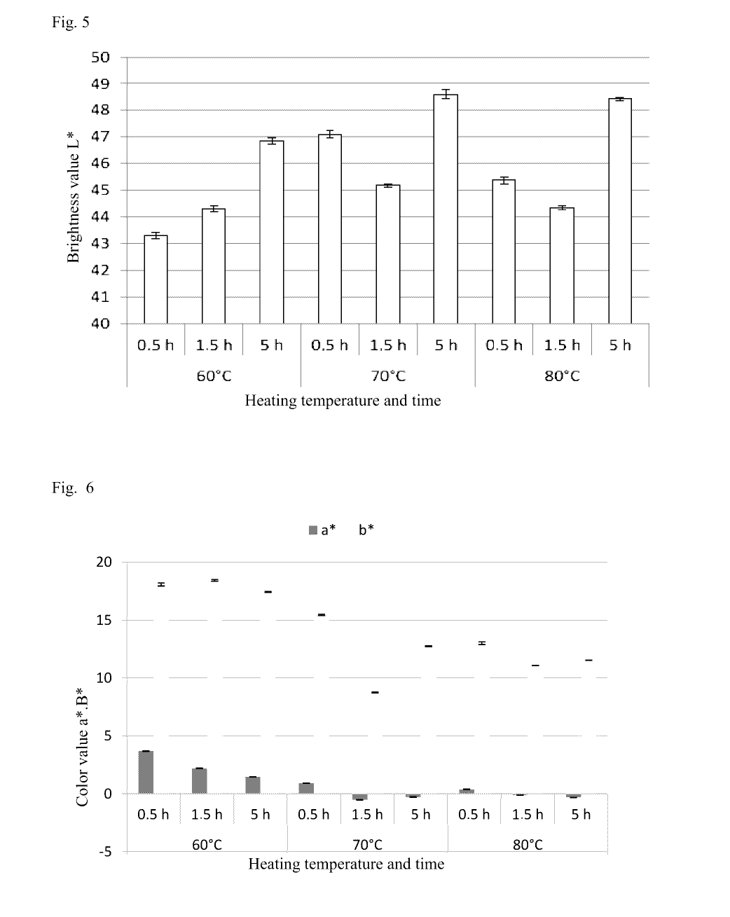

FIG. 6 shows the color values of the aqueous supernatant of the first comminuted raw poultry skin after a first heat treatment;

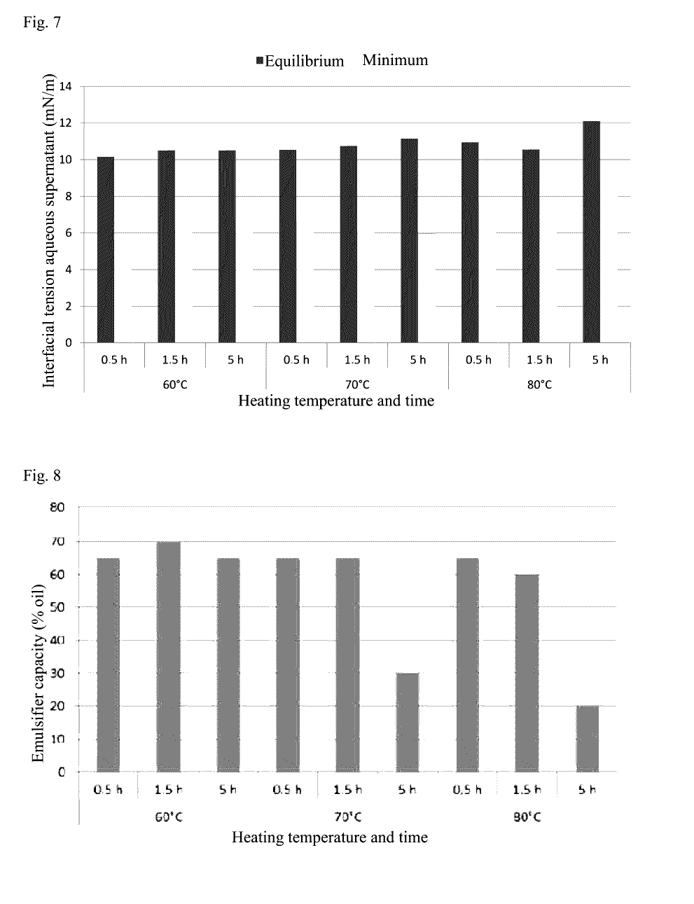

FIG. 7 shows the interfacial activity of the aqueous supernatant of the first comminuted raw poultry skin after a first heat treatment;

FIG. 8 shows the emulsifier capacity of the aqueous supernatant of the first comminuted raw poultry skin after a first heat treatment;

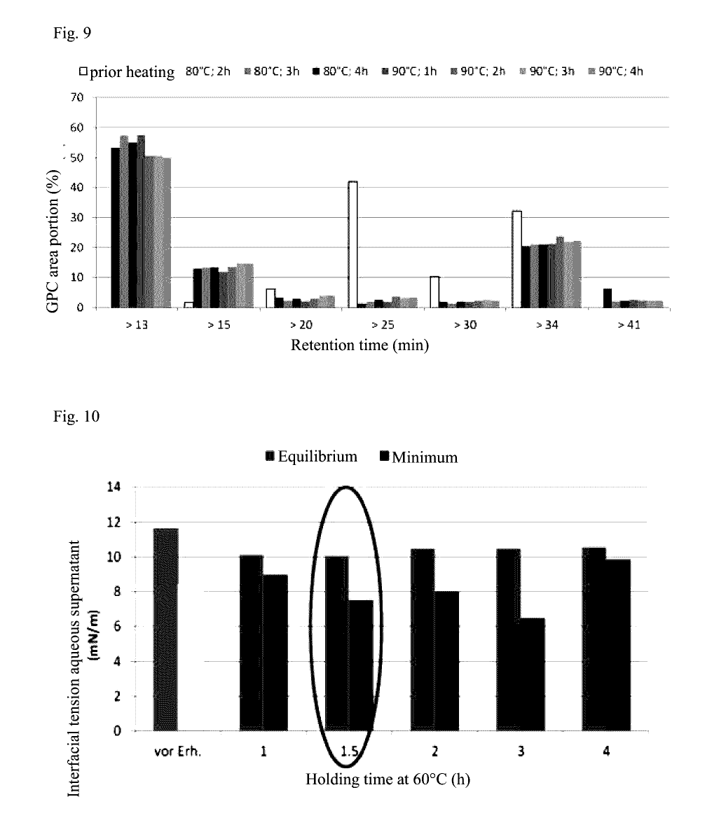

FIG. 9 shows the relative molecular sizes of soluble proteins of the first heated comminuted poultry skin for first heat treatments of different lengths of time in terms of retention times in gel permeation chromatography;

FIG. 10 shows the interfacial activity for the first heat treated comminuted poultry skin after different times of first heat treatment;

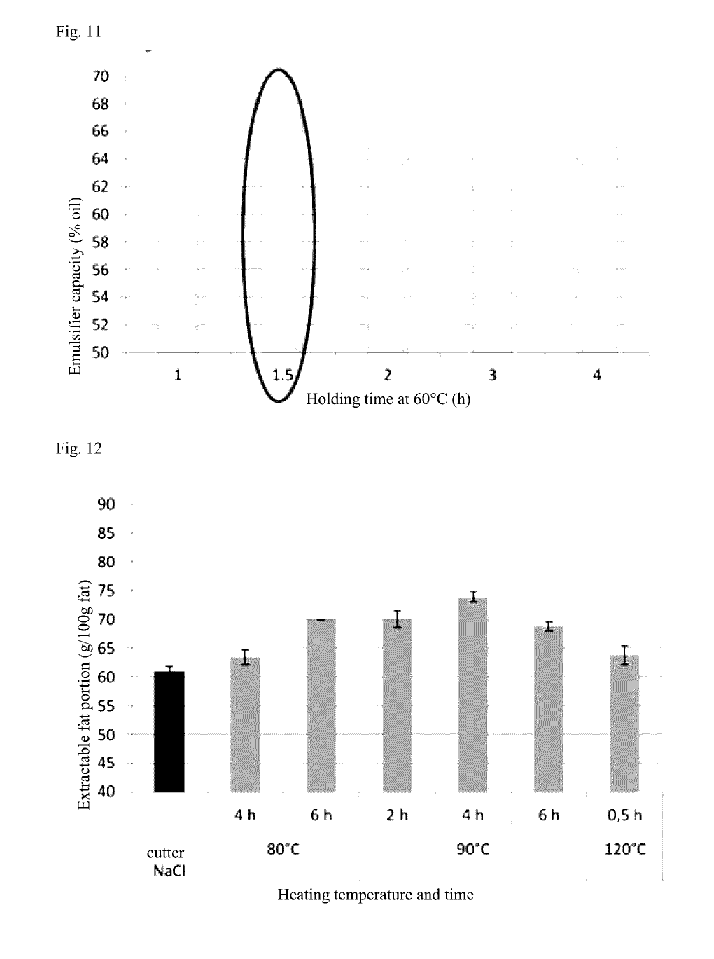

FIG. 11 shows the emulsifier capacity of the first heat treated comminuted poultry skin after different times of first heat treatment;

FIG. 12 shows the analysis of fat extractable from the cooled gel from a second heat treated comminuted poultry skin after different second heat treatments;

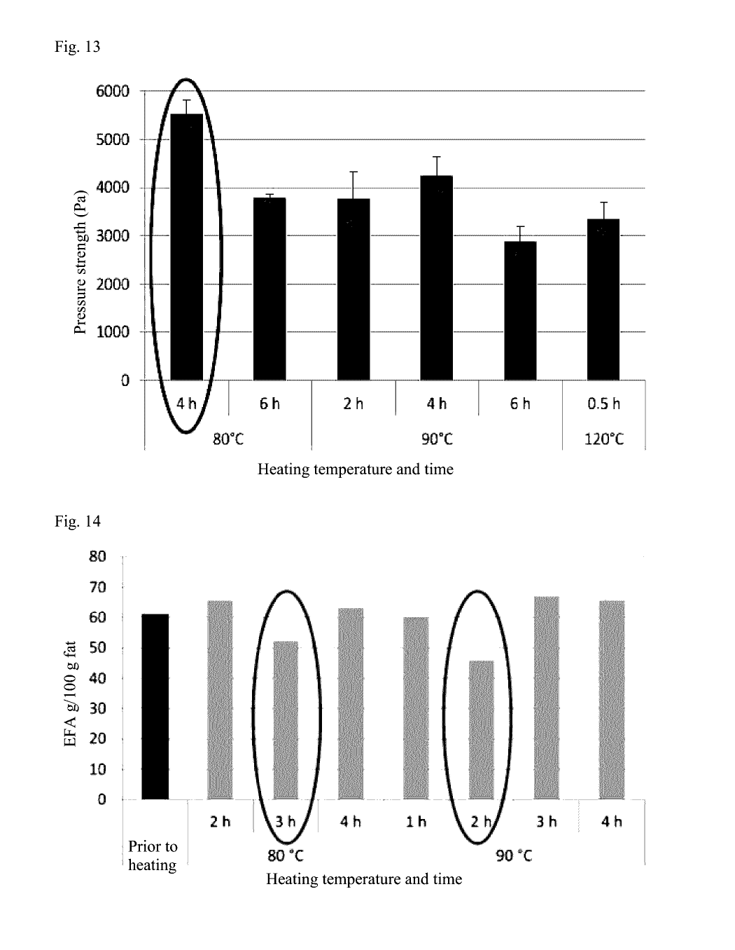

FIG. 13 shows the pressure strength of the cooled gel from a second heat treated comminuted poultry skin after different second heat treatments;

FIG. 14 shows the extractable fat proportion of the cooled gel from a second heat treated comminuted poultry skin after different second heat treatments;

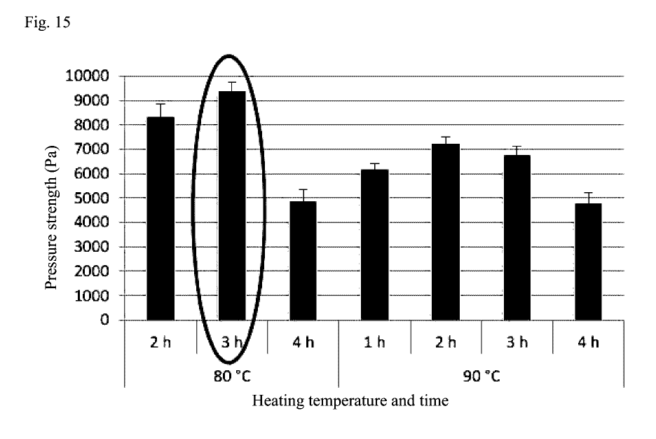

FIG. 15 shows the pressure strength of the heat-treated second comminuted poultry skin in dependence on the second heat treatment;

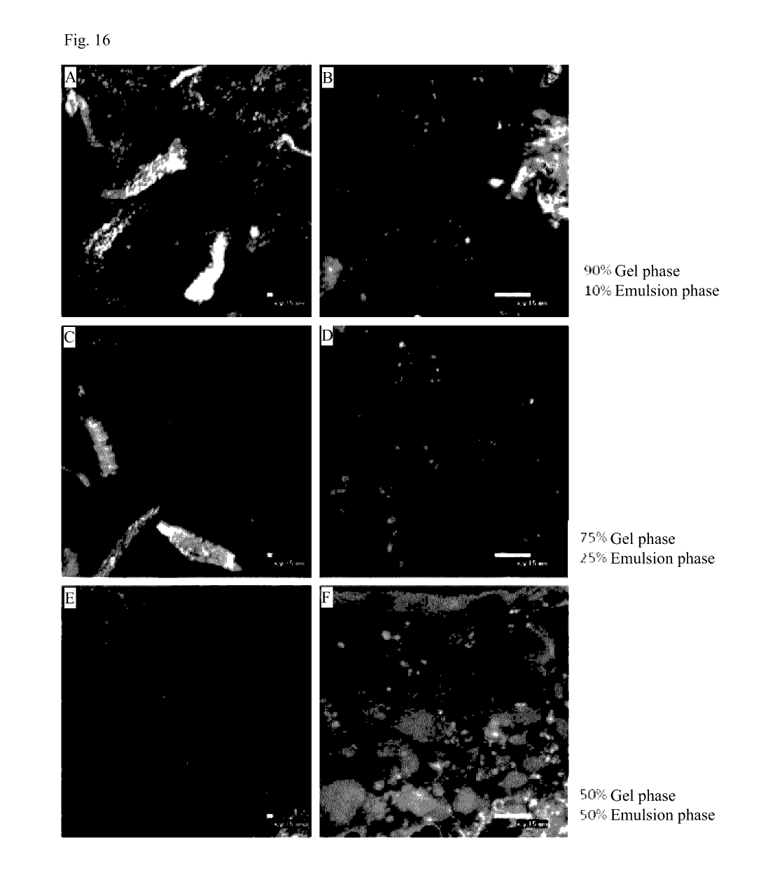

FIGS. 16A-F show microscopic images of the poultry fat product at different mixing ratios of emulsion (emulsion phase) and gel precursor (gel phase) without connective tissue particles;

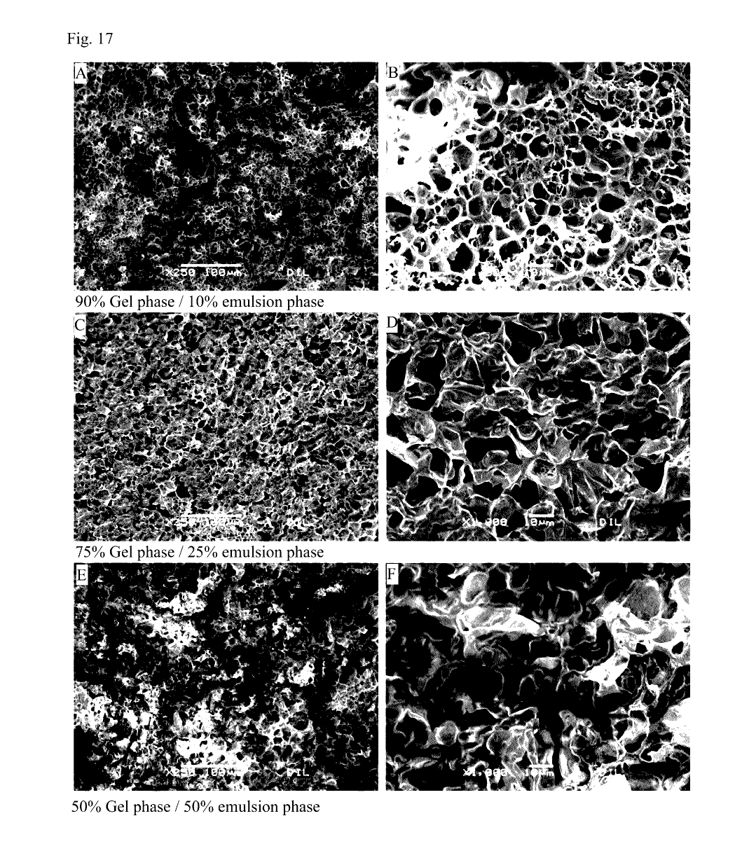

FIGS. 17A-F show scanning electron microscopic images of the poultry fat product at different mixing ratios of emulsion (emulsion phase) and gel precursor (gel phase) without connective tissue particles;

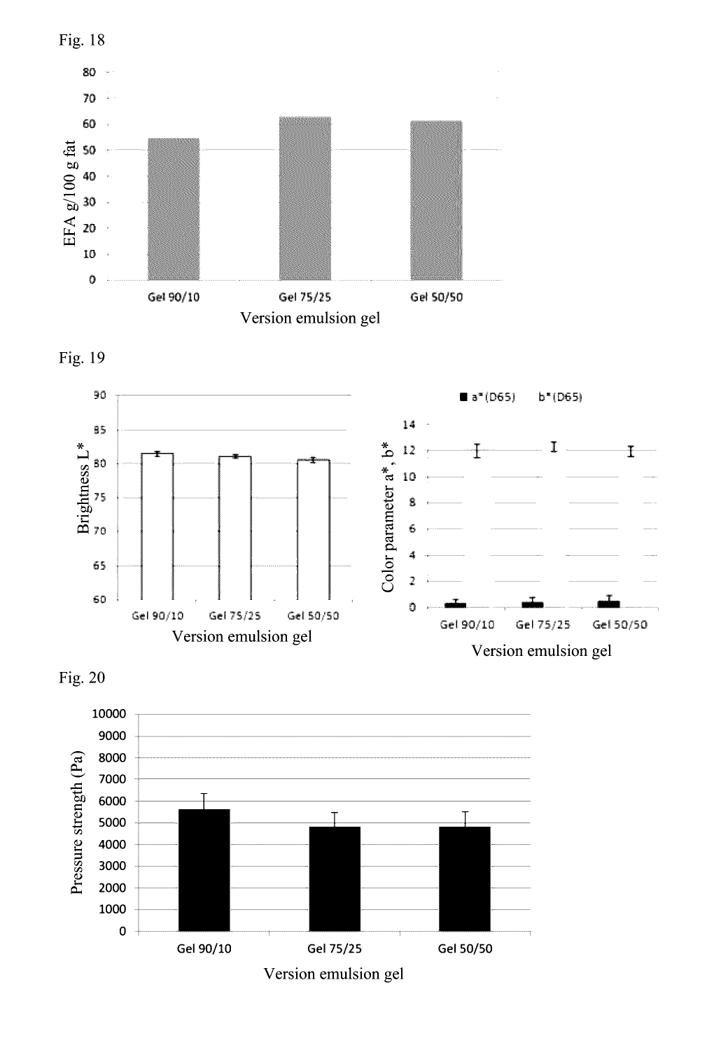

FIG. 18 shows values of the fat proportion extractable from the poultry fat product at different mixing ratios of emulsion and gel precursor (gel) without connective tissue particles;

FIGS. 19A and B show the brightness or color of the poultry fat product at different mixing ratios of emulsion and gel precursor (gel) without connective tissue particles;

FIG. 20 shows the pressure strength of the poultry fat product at different mixing ratios of emulsion and gel without connective tissue particles;

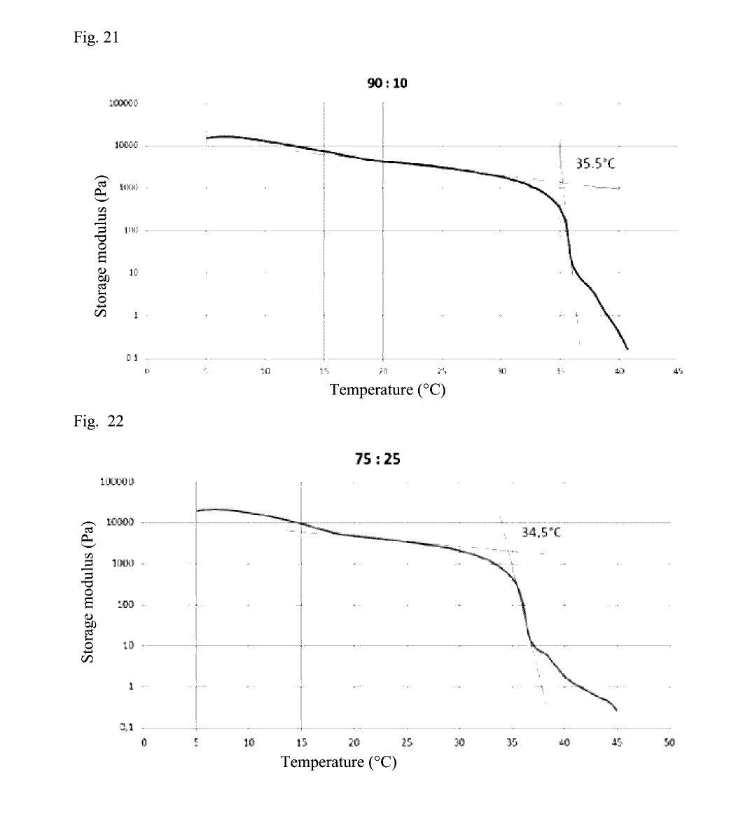

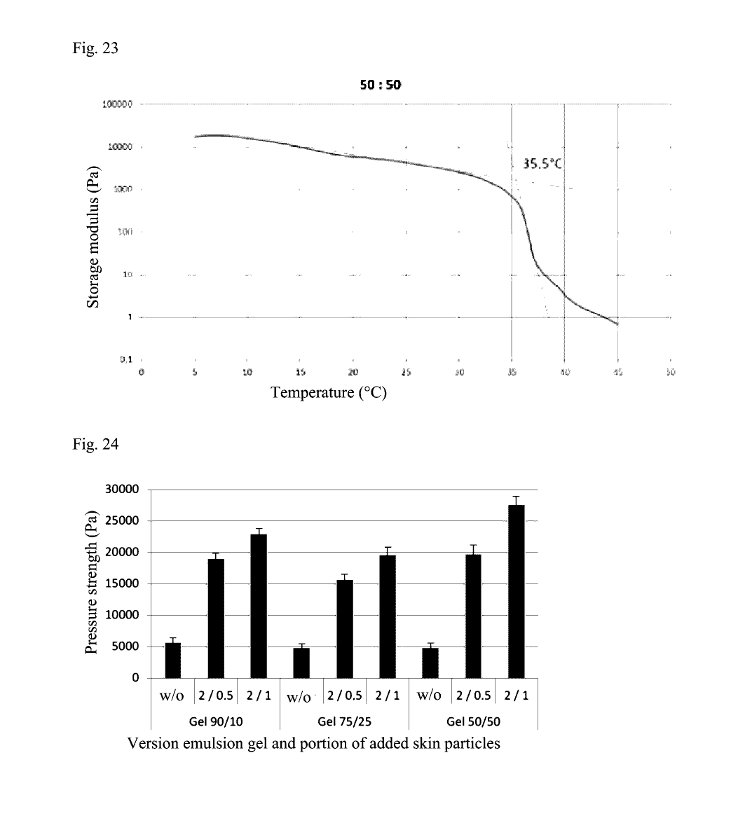

FIGS. 21 to 23 show the temperature stability of the poultry fat product at different mixing ratios of emulsion and gel;

FIG. 24 shows the pressure strength of the poultry fat product having a content of connective tissue particles; and

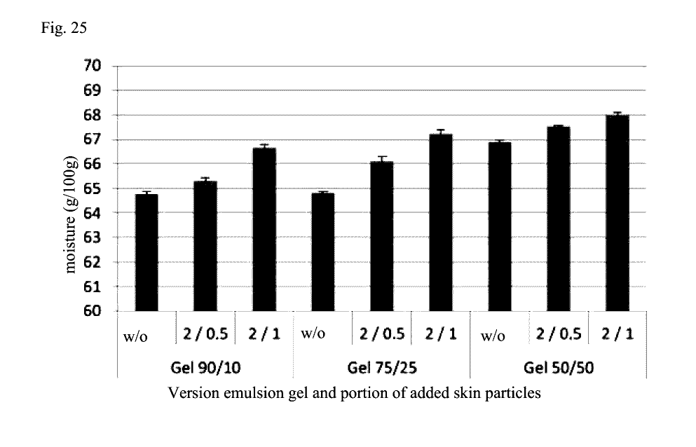

FIG. 25 shows the moistness of the poultry fat product having a content of connective tissue particles.

In the figures, standard deviation is given for triplicate determinations, while the mean value of duplicate determinations is given without standard deviation.

### EXAMPLE

### Production of the Poultry Fat Product

For comminuted poultry skin a grinded raw mixture of 70% (w/w) of chicken breast skin and 30% (w/w) of turkey breast skin containing a water content of from 42.5 (batch 1) to 38.5% (w/w) (batch 2), from 46.2 (batch 1) to 49.5% (w/w) (batch 2) of fat, 9.78 (batch 1) or 10.8% (w/w) (batch 2) of total protein according to Kjeldahl (N*6.25), from 0.82 (batch 1) to 0.90% (w/w) of non-protein nitrogen according to ASU L07.00-14, and from 4.38 (batch 1) to 4.84% (w/w) of connective tissue was used.

Further comminuting of the poultry skin is effected by cutting a 1:1 mixture including water which has been added in the form of ice water during 10 rounds of cutting at 1,500 rpm, followed by 220 rounds of cutting at 5,000 rpm. Alternatively, comminuting is effected in the presence of 1:1 0.95% (w/w) of salt solution (NaCl). As a further alternative, the comminuting may be effected in the presence of ice water or 0.95% (w/w) of salt solution through cutting for 10 rounds at 1,500 rpm, followed by fine grinding in a mill, preferably while cooling, particularly to at maximum 5° C., preferably 3° C. of the mixture. The particle sizes were determined through wet sieving using standard sieves. The particle sizes are given in FIG. 1 as % of passage through the sieves. As a result it is shown that effective comminuting is achieved through cutting, while salt solution during cutting leads to less effective comminuting than water.

The particle sizes of fractions of <1 mm were determined using laser diffraction (Malvern Mastersizer 2000, suspended in tetra-sodium pyrophosphate solution) in terms of the Sauter diameter. Comminuting by cutting yielded a Sauer diameter of 66.8 μm.

The suspensions generated by comminuting were centrifuged to determine the proportions of generated phases. It turned out that the majority of aqueous phase was generated by cutting in the presence of salt containing water. The result is plotted in FIG. 2, namely for the comminuting procedure either in the presence of water (cutter) or salt solution (cutter NaCl). In FIG. 2 the lower section of a column each shows the solid, the middle section shows the liquid supernatant, and the upper section shows the fat/cream layer. The measurement of the interfacial tension (dynamic interfacial tension, measured using a drop volume tensiometer DVT50 (KRÜSS) versus neutral oil) of the respective liquid phases of the suspensions showed an optimum of equilibrium values and minimum values in respect of comminuting through in salt solution; the results are shown in FIG. 3. Therein, a minimum value (right column, minimum) and a small equilibrium value (left column, equilibrium) indicate good emulsion formation or long-term stability of the emulsion. Also the measurement of the extractable fat proportion of the suspensions (by mixing and partitioning with a solvent, preferably petroleum benzene, followed by filtering off, with extracted fat being determined after evaporation of the solvent) shows that by cutting in salt solution (ca. 61% of total fat) an improvement of the interface condition (reduced fat extraction) is achieved compared to cutting in water (ca. 77% of total fat).

The analysis of the size distribution of solved proteins of the aqueous phases generated through cutting in water or salt solution using gel permeation chromatography (GPC, Waters 2695 Alliance Separations Module with Waters 2996 Photodiode Array Detector, Waters, USA; column: Superdex 200 10/300GL (GE Healthcare, Freiburg); isocratic with 0.5 ml/min 0.15 M disodium phosphate, 1% of NaCl (w/w), pH 6.8) showed that a relatively small proportion of high molecular sizes were generated, and that through cutting in salt solution the proportion of high molecular sizes is greater than through cutting in water. The results are shown in FIG. 4, where longer retention times indicate smaller molecules; the proportions are shown in terms of detected area percentages (GPC area proportion (%)), left columns cutting in water (cutting), right column cutting in salt solution (cutting NaCl). The greater proportion of solved protein of small molecular size through comminuting in salt solution supports the better properties of the emulsifier as outlined in the following.

Accordingly, for generating the first comminuted raw poultry skin comminuting through cutting in the presence of salt solution is preferred.

The first heat treatment of the first comminuted raw poultry skin was carried out after cutting in 1:1 salt solution, as generally preferred. In this respect, a temperature of from 55 to 65° C. for from 1 h to 2 h is preferred, in particular of 60° C. for 1.5 h, because this first heat treatment produced the most advantageous combination of brightness, color, interfacial tension and emulsifier capacity. The colors were determined in the L* a* b* color space, where L*=brightness, 0=black, 100=white; +a*=red, −a*=green, +b*=yellow, −b*=blue, from +60 to −60 in each case (measured using Spectralphotometer CM-600d, Konica-Minolta at standard light D65). This color space has a good correlation of geometric and sensed distance between colors.

FIG. 5 shows the brightness values L* after the first heat treatment at 60° C., 70° C., 80° C. for 0.5 h, 1 h and 5 h in each case, FIG. 6 the color values a* (left column) and b* (right column). The brightness and color values show that the first heat treatment each produces a first heat treated comminuted poultry skin with acceptable appearance.

FIG. 7 shows the interfacial tension (equilibrium left column, minimum right column) (drop volume tensiometer DVT 50) of the aqueous supernatant after the first heat treatment (first heat treated comminuted poultry skin), FIG. 8 the emulsifier capacity (determination of the maximal amount of oil emulsified in the laboratory experiment). These results show that with respect to the first heat treatment the optimal combination of interfacial tension and emulsifier capacity is achieved at a temperature in the range of from 55 to 65° C., preferably 60° C., for 0.5 h to 2 h, particularly for ca. 1 h.

The analysis of the protein content after a first heat treatment at 60° C. for from 1 h to 4 h showed that through the first heat treatment the content of soluble protein of the first heated comminuted poultry skin was more or less doubled after 1 h compared to the first comminuted raw poultry skin and hardly increased by extended treatment times. The analysis of the soluble proteins using GPC showed that a first heat treatment at 60° C. for 1 h already produced a significant reduction of the molecule sizes, whereas extended treatment times hardly resulted in a further rise in small molecular sizes. FIG. 9 shows the results of GPC, with the columns of each group being arranged in the order of the legend of FIG. 9; at >13 and >41 the value of “before heating” is zero.

The analysis of the interfacial tension of the aqueous supernatant after a first heat treatment at 60° C. for from 1 h to 4 h shows that the optimal (minimal) equilibrium value is reached after a treatment time of 1.5 h, and also a smaller value of the interfacial tension is reached for the first heat treated comminuted poultry skin. The results are shown in FIG. 10 (equilibrium left column, minimum right column). FIG. 11 shows the results of the measurement of the emulsifier capacity for this first heat treated comminuted poultry skin. The first heat treatment at 60° C. for ca. 1.5 h shows the highest emulsifier capacity.

The emulsification of the first heat treated comminuted poultry skin was effected by fine grinding using a rotor-stator disperser (1,000 rpm, engine, Kotthoff LDF) for about 2 min until the emulsion showed a bright color.

The gel was prepared by grinding the raw poultry skin, as it was used for generating the emulsion, which was comminuted and mixed 1:1 (v/v) with 0.95% (w/w) salt (NaCl) in water to generate the second comminuted poultry skin, which was subsequently subjected to a second heat treatment at 70° C., 80° C. or 90° C. for 2 h, 4 h or 6 h in each case, to generate the second heat treated comminuted poultry skin, and subsequent comminuting of the same. This final comminuting was effected using a laboratory grinder (Blend Tec).

The pressure strength is generally determined at 20° C., e.g. by measuring the force required for pushing a plastic cylinder into the sample for 4 mm. The pressure strength is the pressure corresponding to the exerted force per front surface of the cylinder, in the present case circular, having a diameter of 12.7 mm.

The analysis of the pressure strength (measurement of the force required for pushing in a plastic cylinder of 12.7 mm diameter by 4 mm, determined as the force per cylinder cross sectional area) of the spun down aqueous supernatant of the second heat treated poultry skin after gelatinizing by cooling revealed maxima for a second heat treatment at 90° C. for 4 h (ca. 1,800 Pa) and at 80° C. for 4 h (ca. 1,900 Pa).

FIG. 12 shows the results of the analysis of fat extractable from the cooled gel compared to a second comminuted raw poultry skin (cutter KCl). As evident, the second heat treatment deteriorated the emulsifying properties at elevated temperatures and for extended periods of time. Thus, a second heat treatment to 75° C. to 85° C., preferably 80° C., for from 3 h to 5 h, particularly 4 h, is preferred.

The second heat treatment results in markedly higher values of pressure strength of the cooled gel as shown in FIG. 13 compared to the second comminuted raw poultry skin. In order to achieve a high pressure strength the second heat treatment is thus preferably carried out at from 75° C. to 85° C., more preferably at from 80° C., for from 3 h to 5 h, particularly for 4 h.

The extractable fat proportion (extracted fat/total fat, in %) of the cooled gel from the second heat treated poultry skin compared to untreated second comminuted raw poultry skin is shown in FIG. 14. This result illustrates that also in case of the second heat treatment at 80° C. for 3 h or 90° C. for 2 h the fat is well incorporated within the matrix and, accordingly, is less extractable.

FIG. 15 shows the pressure strength of the heat treated second comminuted poultry skin as a function of the second heat treatment. The maximal strength of the cooled gel is measured for the second heat treatment at 80° C. for 3 h.

A comparison of the measured values in FIGS. 12 and 14, and FIGS. 13 and 15, respectively, for the same process parameters each shows variations between different batches of poultry skin.

Each of the emulsion and precursor were brought to a temperature of 60° C. and mixed to 90% gel precursor+10% emulsion, 75% gel precursor+25% emulsion, or 50% gel precursor+50% emulsion, and cooled in flat containers. The poultry fat product obtained in this way shows after dyeing of protein with FITC (absorption at 492 nm, emission 520 nm, green) and of fat with Nile red (absorption at 554 nm, emission at 606 nm, red) in confocal laser scanning microscopy at excitation with 488 nm and 514 nm or 488 nm, 568 nm and 647 nm a homogenous distribution of fat predominantly in drop shape, and a homogenous distribution of protein with only a very low amount of denatured protein. The microscopic images are shown in FIG. 16, in (A) and (B) for 90% gel+10% emulsion, in (C) and (D) for 75% gel+25% emulsion, and in (E) and (F) for 50% each of gel and emulsion, at different magnifications.

FIG. 17 shows scanning electron microscopic images (samples frozen in liquid nitrogen, broken through cryo-preparation, free water sublimated at −10° C. and vapor-deposited with gold, image taken at −185° C. in a vacuum) of the poultry fat product, in (A) and (B) for 90% gel+10% emulsion, in (C) and (D) for 75% gel+25% emulsion, and in (E) and (F) for 50% each of gel and emulsion, each at different magnifications. The images show that at 10% emulsion the protein network structure of the gel is essentially preserved, and this structure becomes more compact with an increasing amount of emulsion. At 75% gel+25% emulsion, the poultry fat product shows relative large gaps or blank volume, facilitating the leakage of water, e.g. when being contacted with salt, and leading to decreased strength.

The extractable fat proportion is shown in FIG. 18. These values in the range of 53% to 63% of total fat show sufficient stabilization of the fat in the poultry fat product.

The results of the optical analysis in FIG. 19 show sufficient brightness and acceptable color of the poultry fat product.

FIG. 20 shows the pressure strength of the poultry fat product of the indicated mixtures of gel and emulsion. The pressure strength for 25% and 50% emulsion are more or less the same. This is currently ascribed to the more compact structure of the poultry fat product with 50% each of gel and emulsion.

FIGS. 21, 22 and 23 resp. show the temperature stabilities of the poultry fat products, determined in terms of storage modulus G′, reflecting the tension of the reversible stretch of the internal structure of the poultry fat product and thus being a measure of the strength of the indestructible structure. Therein, a greater storage modulus indicates a greater internal strength of the poultry fat product. The measurement was carried out at a frequency of 1 Hz and a temperature in the range of 5° C. to 45° C. The deduced boundary temperatures of the temperature stability are indicated each and show that the poultry fat product gelatinizes thermo reversibly and has sufficient strength, in particular with respect to a processing temperature of at maximum 5° C. and a storage temperature of at maximum 25° C.

FIG. 24 shows the pressure strength of the poultry fat product of the preferred embodiment with additional particles of connective tissue from which liquid was separated. With respect to the situation without additional particles of connective tissue (without), 5% (w/w) connective particles (2/0.5) or 10% (w/w) connective particles (2/1) the values for 90% gel+10% emulsion, 75% gel+25% emulsion, and 50% each of gel and emulsion, the values are shown. These results show that by admixing connective tissue particles the pressure strength of the poultry fat product may be increased to from 4-fold to 5-fold.

FIG. 25 shows the water content (moistness, %) of the poultry fat product of the preferred embodiment with admixed particles of connective tissue. The samples correspond to those of FIG. 24. As shown by the measured values (drying at 105° C. until mass constancy), the water content of the poultry fat product is ca. 15% to 18% higher compared to bacon from pork.

1. A process for producing a poultry fat product comprising the steps of:
comminuting a first raw poultry skin mixed with water for generating a first comminuted raw poultry skin;
a first heat treatment of the first comminuted raw poultry skin at from 55° C. to 75° C. for from 1 to 3 h for generating a first heat treated comminuted poultry skin;
emulsifying the first heat treated comminuted poultry skin by fine grinding for producing an emulsion;
comminuting a second raw poultry skin for generating a second comminuted raw poultry skin and mixing with water;
a second heat treatment of the second comminuted raw poultry skin at from 70° C. to 90° C. for from 1 to 5 h for generating a second heat treated comminuted poultry skin;
comminuting the second heat treated comminuted poultry skin for producing a gel precursor;
bringing the emulsion and the gel precursor to a temperature involving a tolerance of at maximum 5° C. and mixing the emulsion and the gel precursor, the temperature being from 30° C. to 60° C., for generating a mixture of emulsion and gel precursor; and
cooling the mixture of emulsion and gel precursor.

2. The process according to claim 1, characterized in that comminuting the first poultry skin is effected by grinding, followed by mixing with the water and cutting at from about 0 to 10° C.

3. The process according to claim 1, characterized in that from 0.7 to 2% of salt (w/w) is added to the water of the first and/or second raw poultry skin.

4. The process according to claim 1, characterized in that water at a weight portion of from 1:0.5 to 1:2 is added to the first and/or second raw poultry skin.

5. The process according to claim 1, characterized in that the first heat treatment is carried out at from 55° C. to 65° C. for from about 1 to 2 h.

6. The process according to claim 1, characterized in that comminuting the second raw poultry skin is effected by grinding, followed by mixing with water and cutting.

7. The process according to claim 1, characterized in that the second heat treatment is carried out at from 75° C. to 85° C. for from about 2.5 to 3.5 h.

8. The process according to claim 1, characterized in that particles of connective tissue are generated by cooking comminuted poultry skin in water or steam, followed by separating liquid, and these particles of connective tissue are added to the mixture of emulsion and gel precursor prior to cooling.

9. The process according to claim 1, characterized in that the cooled mixture of emulsion and gel precursor is contacted with salt after gelatinizing and leaked liquid is separated from the cooled mixture.

10. The process according to claim 1, characterized in that the cooled mixture of emulsion and gel precursor is comminuted, mixed with comminuted poultry lean meat and food additives, and cased.

11. A poultry fat product, obtainable by a process according to claim 1.

12. The poultry fat product according to claim 11, characterized by a pressure strength at 20° C. of at least 4,800 Pa, a brightness value L* of at least 80, and an extractable fat proportion of at maximum 65%.

13. The poultry fat product according to claim 11, characterized by a pressure strength of at least 22,000 Pa and a softening temperature of at least 34° C.

14. Use of raw poultry skin as a first and second raw poultry skin in a process according to claim 1.
